(19) United States
(12) Patent Application Publication
(10) Pub. No.: US 2019/0316596 A1
(43) Pub. Date: Oct. 17, 2019

(54) Impeller with rotor blades for centrifugal pump

(71) Applicant: IHC Holland IE B.V., Sliedrecht (NL)

(72) Inventors: Edwin Albert Munts, Sliedrecht (NL); Hasan Hüseyin Bugdayci, Sliedrecht (NL)

(73) Assignee: IHC Holland IE B.V., Sliedrecht (NL)

(21) Appl. No.: 16/468,758

(22) PCT Filed: Dec. 21, 2017
(86) PCT No.: PCT/NL2017/050868

§ 371 Date: Jun. 12, 2019

(30) Foreign Application Priority Data
Dec. 22, 2016 (NL) 2018044

(51) Int. Cl. F04D 29/22; F04D 29/24; E02F 9/20; E02F 5/00; E02F 3/90; E02F 3/88

(52) U.S. Cl. CPC F04D 29/22; F04D 29/242; E02F 3/8833; E02F 5/006; E02F 3/90; E02F 9/20

(57) ABSTRACT

An impeller for a centrifugal pump comprises a rotor; a shaft shield connected to the rotor and having an axial supply; a suction shield connected to the rotor and axially set apart from the shaft shield; and a plurality of blades between the shaft shield and suction shield and connected to the rotor. Each blade comprises a leading edge and a trailing edge connecting between the shaft shield and the suction shield and a suction side and a pressure side, wherein each blade cross-section is thicker near the leading edge on the suction and pressure sides, and tapers to a thinner cross-section near the trailing edge. Each blade connects to the suction shield at the leading edge with an extensive fillet providing curvature toward the suction shield along the leading edge.

### BACKGROUND

Dredging is amongst the most demanding of industries in relation to wear for all the equipment in direct contact with the dredged mixture flow. This includes the dredge pump, typically a centrifugal pump and the interior components of the pump. The pump impeller is especially prone to wear, as it encounters a high velocity difference between the mixture and impeller itself. As the pump is at the heart of the dredging process, the dredge pump has a high impact on the productivity of the overall dredging vessel.

Impellers of early dredge pump designs consisted of two flat shrouds with simple blades extending between. Each blade was curved with a single curve, most commonly with a circular shape. The blade angles were calculated for an estimate of the best efficiency point and typical working conditions of the pump. The shape of the blade was formed by simple plate-like sides with uniform thickness along the length of the blade. Such blades are still used in dredge pumps operating around the world.

The next step in dredge pump evolution was the introduction of curved shrouds or shields and double curved blades. These curved shrouds and double curved blades improved pump performance, in particular with respect to hydraulic efficiency. The uniform thickness of the blades generally remained the same though.

The first change into a varying impeller blade thickness came with a new design for a large spherical passage pump, shown in WO2012/074402. For this impeller, the thickness of the blades was enlarged at the leading edge to enhance its suction capabilities. This increase in thickness, however, was only a minor change in the thickness, about a 12% change in thickness between the thickest and thinnest parts of the blade cross-section, and in practice was barely noticeable. As disclosed in WO2012/074402, adding a strip of material to the blades along the radial inner ends to change the curvature of the blade can help in controlling flow and energy transfer from the blades to the mass being pumped. The strip is disclosed as covering up to 10% of the total length of the rotor blade from the radial inner end to radial outer end. A further development of this blade was made and presented at a conference. The blade had an increased thickness on the suction side. The blade presented can be seen in FIG. 3B. Such an increase in thickness on only one side can result in wear that leads to sharp edged and flow separation.

The dredge pump of U.S. Pat. No. 2,262,039 comprises impellers having a thickness of the blades being enlarged at the trailing edge, so when sand circulates through the interior of the pump, the impeller can resist such an impact and wear of the trailing edge of the blade for longer period of time. Besides, as it is intended in U.S. Pat. No. 2,262,039, the fillets comprise a number of openings that are meant to provide securing means of the impeller to the shield by means of bolts seated in those openings. The impeller disclosed in U.S. Pat. No. 2,262,039 has as a main drawback that it is subject to breakage due to presence of leading edge vortex that will have a major impact on the leading edge of the blade as well as of some other parts of the pump. Moreover, the blade itself is prone to misalignment when objects impact a number of times, which can affect the tightness of the bolts and this could create serious problems in the operation of the pump having this kind of blades.

### SUMMARY

An impeller for a centrifugal pump comprises a rotor; a shaft shield connected to the rotor and having an axial supply; a suction shield connected to the rotor and axially set apart from the shaft shield; and a plurality of blades between the shaft shield and suction shield and connected to the rotor. Each blade comprises a leading edge and a trailing edge connecting between the shaft shield and the suction shield and a suction side and a pressure side, wherein each blade cross-section is thicker near the leading edge on the suction and pressure sides, and tapers to a thinner cross-section near the trailing edge. Each blade connects to the suction shield at the leading edge with an extensive fillet providing curvature toward the suction shield along the leading edge.

Providing a blade that is thicker on pressure and suction side near the leading edge and has an extensive fillet providing curvature toward the suction shield at the leading edge helps to avoid leading edge vortices and therefore increase the working performance and efficiency of the impeller and pump. The avoidance of a leading edge vortex (LEV) is a key feature in the high performance of dredge pumps. Prior art dredge pumps all suffer from LEV, causing damage to impeller or other parts of the pump. This avoidance is achieve by the extensive fillet, and improving the contact surface of the impeller with the front and/or back shrouds or shields. It should be noted that the fillet can be finished when modifying the blade or impeller such that the shape and dimensions are tailor-made for specific centrifugal dredge pumps having different dimensions or working requirements.

According to an embodiment, each blade comprises forward sweep. Providing forward sweep can help to improve flow uniformity, resulting in higher hydraulic efficiency. Additionally, wear characteristics can be improved, as the blade will wear down to an unswept state, thereby increasing the blade and/or impeller workable lifespan.

According to an embodiment, the cross-section of each blade is 25% to 80% thicker at the thickest point near the leading edge than near the trailing edge. By increasing the thickness near the leading edge on both the pressure and the suction side, blade is able to ensure that flow separation is avoided over a large working range, perhaps the entire working range of the specific impeller. Further, adding material for a thicker blade at the leading edge can also improve blade resistance to wear and ensure that the blade maintains a smooth, rounded shape even when the blade experiences wear. The smooth rounded shape helps to maintain smooth flow and pump performance.

Optionally, the thicker cross-section can be formed of a fillet which wraps around the leading edge of the blade and has a standard thickness that extends to both the pressure side and the suction side at the leading edge. This standard thickness can be, for example, about the same thickness as the original blade shape the fillet is wrapping around. Further optionally, this standard thickness can extend about 10% of the blade length between leading edge and trailing edge before tapering toward the trailing edge.

According to an embodiment, each blade has a maximum cross-sectional thickness at 5% to 30% along the length of the blade between the leading edge and the trailing edge, after which the blade tapers in cross-sectional thickness toward the trailing edge. Such a shape can help to ensure smooth flow and operation of the impeller.

According to an embodiment, a blade wrap angle of each blade is variable. Optionally, the blade wrap angle is between 0 and 60 degrees with a forward sweep. A variable blade wrap angle with a forward sweep can help blade wear characteristics, ensuring that incident flow does not impact perpendicular on the blade leading edge, resulting in less wear.

According to an embodiment, the fillet extends over 10% to 50% of the leading edge length between suction and shaft shields. Such an extensive fillet can help to protect the leading edge of the blade and ensure better flow and wear characteristics in the impeller.

According to an embodiment, the fillet height along the suction shield is 20% to 75% of the blade thickness. Such a fillet helps to guide flow to improve impeller performance and wear characteristics.

According to an embodiment, the blade connects to the shaft shield with a fillet at the leading edge. Such a fillet can be similar to the fillet connecting the blade to the suction shield, and can improve impeller performance and wear characteristics in a similar manner.

According to a further aspect of the invention, a centrifugal pump comprises the impeller described, and further comprises a pump housing with an axial inlet and an outlet. The impeller is connected to the pump housing through the rotor being connected to the pump housing such that the rotor can rotate around an axis A; and the shaft shield has the axial supply aligned with the axial inlet.

According to another aspect of the invention a vessel can include the centrifugal pump described above.

According to an aspect of the invention, a blade can be provided for such a centrifugal pump. The blade comprises a leading edge and a trailing edge, with a cross-section which is at least 50% thicker near the leading edge than near the trailing edge and tapers between. The part near the leading edge is thicker on both suction and pressure sides of the blades. This thickness can be equally added on both the pressure and suction sides, for example, by wrapping a fillet extending around the leading edge of the blade and extending toward the trailing edge on the pressure and suction sides. Optionally, the fillet can have a standard thickness which extends for about 10% of the blade length between leading edge and trailing edge before tapering.

According to a further aspect of the invention, a method of modifying a blade for a centrifugal pump comprises adding material to the blade at and near the leading edge to the suction and pressure sides of the blade; and tapering the added material in a direction toward the trailing edge. Such a method can adapt new or prior art blade into a blade for an impeller can help to promote smooth flow and overall impeller and pump efficiency as well as improve wear characteristics. Adding material at the leading edge can reduce or eliminate the formation of horse-shoe vortices at the leading edge and increases the range around the best efficiency point where flow remains attached to the blade.

According to an embodiment, the step of adding material to the blade at and near the leading edge comprises wrapping material around the leading edge and extending toward the trailing edge on both sides of the blade such that the material is a constant thickness for 10% of the blade length between leading edge and trailing edge. By using material that is a constant thickness for about 10% of the blade length, a large increase in the range at which flow remains attached to the blade can be seen. This range is also beneficial for the wear characteristics, greatly increasing the thickness near the leading edge, and then tapering to use less material and therefore have a lighter blade where the thickness is not needed.

According to an embodiment, the material added is the same material as that of the blade. This can include the exact same material, or partially the same material, for example, alloys or mixtures of the same material and another material.

### SHORT DESCRIPTION OF DRAWINGS

The present invention will be discussed in more detail below, with reference to the attached drawings, in which

FIG. 1 is a front view in cross section of a centrifugal pump,

FIG. 2 is a side view in cross section along the line II-II in FIG. 1.

FIG. 3A shows a cross-section of a blade according to the prior art;

FIG. 3B shows a cross-section of a second blade according to the prior art; and

FIG. 3C shows a cross-section of a blade according to an embodiment of the current invention.

FIG. 4A is a perspective view of the prior art connection between the blade leading edge and a shroud, and

FIG. 4B is a side view of the blade of FIG. 5A, showing the prior art connections between the leading edge and the front and rear shrouds.

FIG. 5A shows a perspective view of the blade leading edge and shroud connection according to an embodiment of the current invention; and

FIG. 5B shows a side view of the blade of FIG. 6A, showing the connections between the blade leading edge and the front and read shrouds.

FIG. 6 shows a perspective view of a blade according to the current invention, and showing the blade wrap angles.

### DESCRIPTION

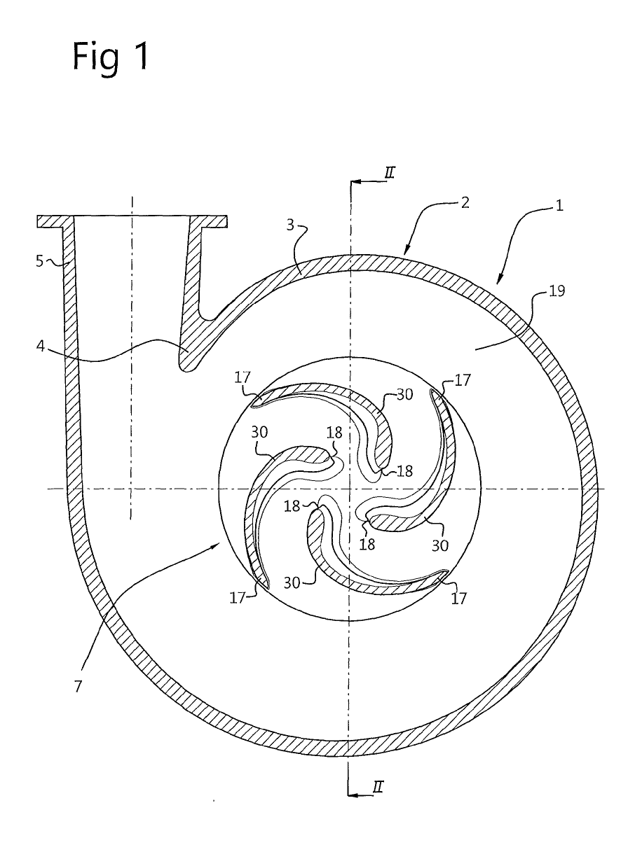

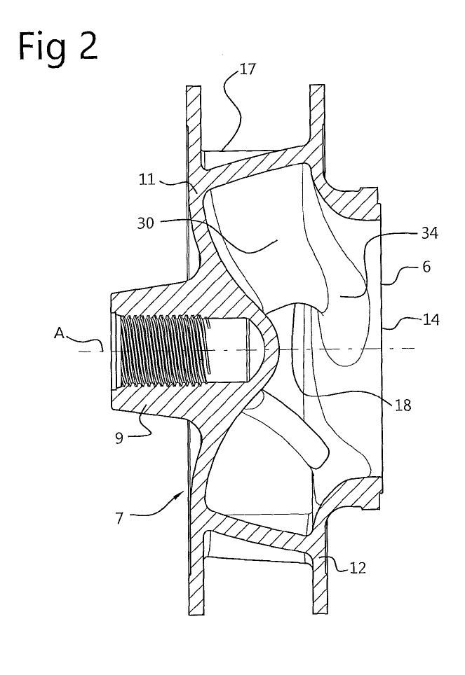

FIG. 1 is a front view in cross section of a centrifugal pump 1, and FIG. 2 is a side view in cross section along the line II-II in FIG. 1.

Centrifugal pump 1 comprises a pump housing 2 shaped like a volute (spiral casing). The pump housing 2 has a circumferential wall 3 and a spout-shaped outlet 5 attached tangentially to the circumferential wall 3 of the pump housing 2. The junction between the inner surface of the tangential outlet 5 and the inner surface of the circumferential wall 3 of the pump housing 2 defines what is known as a cutwater 4. The pump housing 2 also has an axial inlet 6.

A rotor 7 is attached in the pump housing 2 such that it may rotate about an axial rotation axis A. The rotor 7 has a central boss 9 which may be fastened to a drive shaft (not shown). A shaft shield 11 extends from the central boss 9. The shaft shield 11 forms a first wall or shroud for delimiting the flow within the rotor 7. Axially set apart from the shaft shield or back shroud 11, the rotor has a suction shield or front shroud 12 which defines a second wall for delimiting the flow within the rotor 7. The suction shield 12 has an axial supply 14 which is aligned with the axial inlet of the pump housing 2.

A plurality (four in FIGS. 1 and 2) of rotor blades 30 are fastened between the shields 11, 12, whereby the blade 30 leading edge 18 and front shroud 12 are joined through a connection 34 with a fillet. In this illustrative embodiment, the rotor 7 comprises four rotor blades 30. The rotor blades 30 each extend substantially radial to the rotation axis A. Each rotor blade 30 comprises a leading edge 18 and a trailing edge 17. The leading and trailing edges 18, 17 extend between the shaft shield 11 and the suction shield 12. Between the trailing edges 17 of the rotor 7 and the inner surface of the circumferential wall 3 of the pump housing 2 there is a circumferential channel 19. The circumferential channel 19 has a passage surface area which increases somewhat in the circumferential direction from the cutwater 4 toward the outlet 5.

During operation, the rotor 7 rotates about the rotation axis A. Between the rotor blades 30, the mass to be pumped is forced radially outward into the pump housing 2 under the influence of centrifugal forces. Said mass is then entrained in the circumferential direction of the pump housing 2 toward the tangential outlet spout 5 of the pump housing 2. The pumped mass which, after leaving the rotor 7, is entrained in the circumferential direction of the pump housing 2 flows largely out of the tangential outlet of the pump housing 2. A small amount of the entrained mass recirculates, i.e. flows along the cutwater back into the pump housing 2.

Said centrifugal pump 1 can be used in dredging operations. If the centrifugal pump 1 is located on board a dredging ship, such as a cutter suction dredger or hopper suction dredger, the centrifugal pump 1 has to fetch a loose mixture of substances, possibly including soil, stones and/or pebbles, from the sea floor. This mixture passes through pump 1, and can cause a large amount of wear on pump 1 and pump components, particularly blades 30.

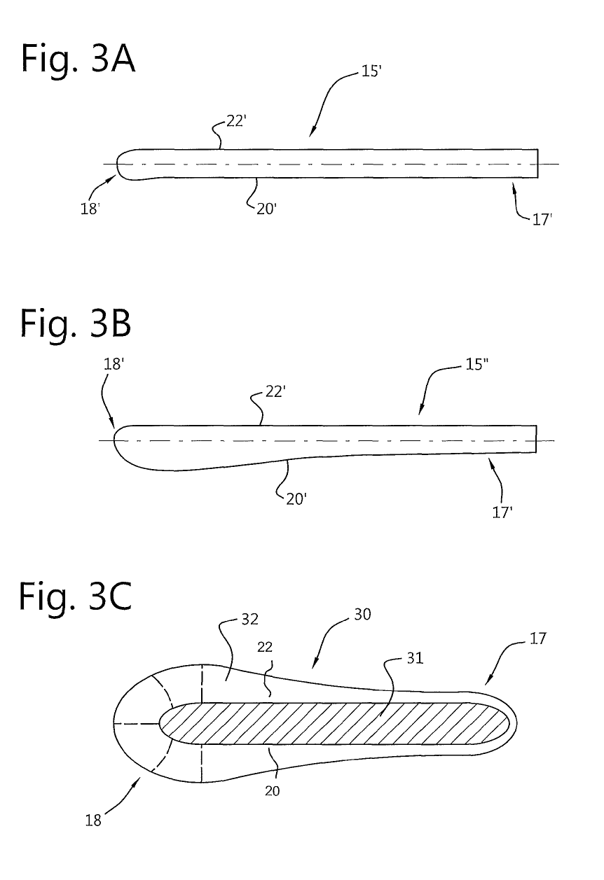

FIG. 3A shows a cross-section of a blade 15′ according to the prior art, FIG. 3B shows a second prior art blade 15″. Blades 15′, 15″ includes leading edge 18′ and trailing edge 17′. As can be seen in the cross-section, blade 15′ has a thickness which is substantially the same from the leading edge 18′ to the trailing edge 17′, with a small increase in thickness near the leading edge 18′. The thickest section of blade 15′ is about 12% thicker than the thinnest section in this prior art blade. Blade 15″ had a larger increase in thickness at leading edge, though this is only on the suction side 20′ and not on the pressure side 22′.

In prior art pumps, blades 15′ typically have a rather sharp leading edge 18′ which is designed for the pumps best efficiency point (“BEP”). This is the design point where the blade and incident flow are usually aligned, such that the flow incidence angle is close to zero, also referred to as the shock-free entrance condition. At flow rates beyond the BEP, the incidence angle increases, and when it becomes too large, the flow is no longer able to follow the blade contour and separates from the blade surface. This has a negative effect on the suction capacity of the centrifugal pump, reducing overall pump efficiency. It also may result in cavitation and subsequent wear of the centrifugal pump.

FIG. 3C shows a cross-section of a blade 30 according to the current invention. Blade 30 has a leading edge 18, trailing edge 17, suction side 20 and pressure side 22. At and near leading edge 18, blade 30 has an increase in thickness around both the suction side 20 and pressure side 22. This increase in thickness is substantial, for example in the range of 25%-100% thicker at the thickest part of blade 30 than at the thinnest. This can be even higher in many cases, up to 200%-300% thicker at the thickest part than the thickness of original blade 31. There is a taper between the thicker part near the leading edge 18 and the trailing edge 17 for a smooth transition between the thickest part and the thinner part. Blade 30 is shown having a thickest part which is about 80% thicker than the thinnest part.

In FIG. 3C, blade 30 is thickened at and near the leading edge 18 by adding an extensive fillet 32 which wraps around an original blade shape 31 on both suction side 20 and pressure side 22 of blade 30. This fillet 32 has a variable radius, starting with a large radius at the blade leading edge, while gradually decreasing to a small radius at the blade trailing edge. Fillet 32 can be the same material of original blade 31 or a different material. Fillet 32 has a large, constant radius which wraps around about the first 10% of blade 30 at leading edge 18. Fillet 32 then tapers toward trailing edge 17 such that blade cross-section is thinner at trailing edge 17. The width of fillet 32 at leading edge 18 can be about the same thickness of blade 31, resulting in a width of blade 30 near leading edge 18 of up to 300% the thickness of blade 31. Further, the width of fillet 32 near leading edge 18 can about twice as thick as fillet 32 thickness at an intermediate point between leading edge 18 and trailing edge 17.

The blade 30 can be formed in this shape, or can be formed by adding material later to a prior formed blade 31, and machined to form a smooth taper. Such a method can be used to modify prior art blades to have better flow and wear characteristics, making the formation of blades 30 even more economical by not having to form and replace prior art blades 15′, 15″ with entirely new blades.

By making the blade 30 with a profile that is thicker at the leading edge 18 on both pressure and suction sides 20, 22 than at a thinnest part near trailing edge 17, in the range of at least 25% thicker, for example, 40%-100% thicker, blade 30 is less sensitive to the flow incidence angle, allowing flow to remain attached to the blade surface even at larger incidence angles. By increasing the thickness at and near leading edges 18, blade 30 has a larger range around its BEP where flow remains attached, keeping a smooth flow and efficiency in the pump over a large flow range. This can be especially helpful with decreased flow rates with increased incidence angles and avoiding the formation of vortices at the leading edge. Such a substantial increase in thickness can result in the blade 30 being able to prevent flow separation at all flow conditions within the pump working range. The ability to maintain attached flow also leads to the leading edge 18 maintaining its rounded shape during wear through use. Prior art blades, such as the ones shown in FIGS. 3A-3B, had a tendency to form a sharp edge at suction side 20′ as they were worn down through use. Because of the ability to maintain attached flow and fillet 32 wrapping around both sides of blade 30, blade 30 maintains a smooth rounded shape with even wear, leading to better pump efficiency even as blade 30 experiences wear.

Additionally, this increase in thickness at leading edge 18 provides extra “wear material” in the region of highest wear of the blade 30. This works to increase the overall blade 30 and pump 1 lifespan. Further, fillet 32 works to reduce horse-shoe vorticity wear on blade 30. The large radius at the front portion of the blade 30 serves to prevent the formation of a horse-shoe vortex at the intersection of the blade leading edge 18 with the front and back shrouds. The horse-shoe vortex forms when the flow along the shrouds impact frontally on the blade leading edge 18. The fillet 32 serves to avoid this frontal impact, and therefore the horse-shoe vortex formation, by gradually guiding the flow over the blade leading edge 18. Note that the large fillet radius wraps around the blade leading edge 18, therefore, frontal impact is avoided for a range of incidence angles corresponding to a working range around the best efficiency point. As a result, wear properties are improved not just at the best efficiency point but over a range below and above the best efficiency point.

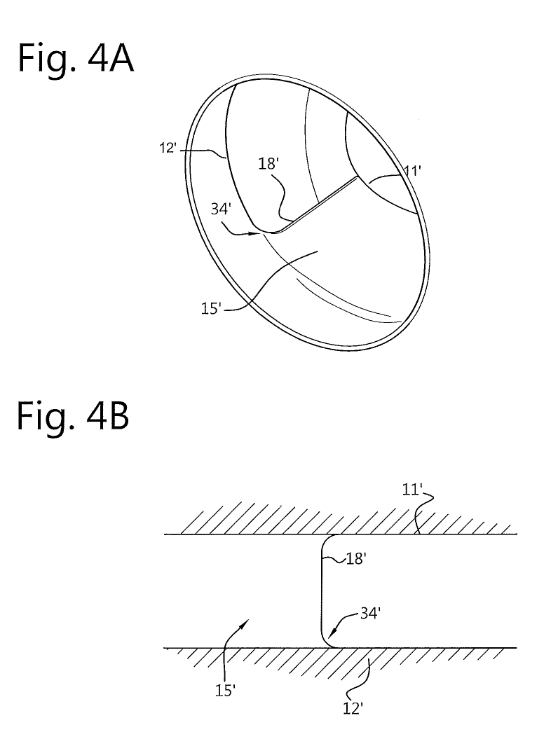

FIG. 4A is a perspective view of the prior art connection 34′ between a blade 15′ leading edge 18′ and a front shroud 12′, and FIG. 4B is a side view of blade 15′, showing the prior art connection 34′ between the leading edge 18′ and the front and rear shrouds 12′, 11′.

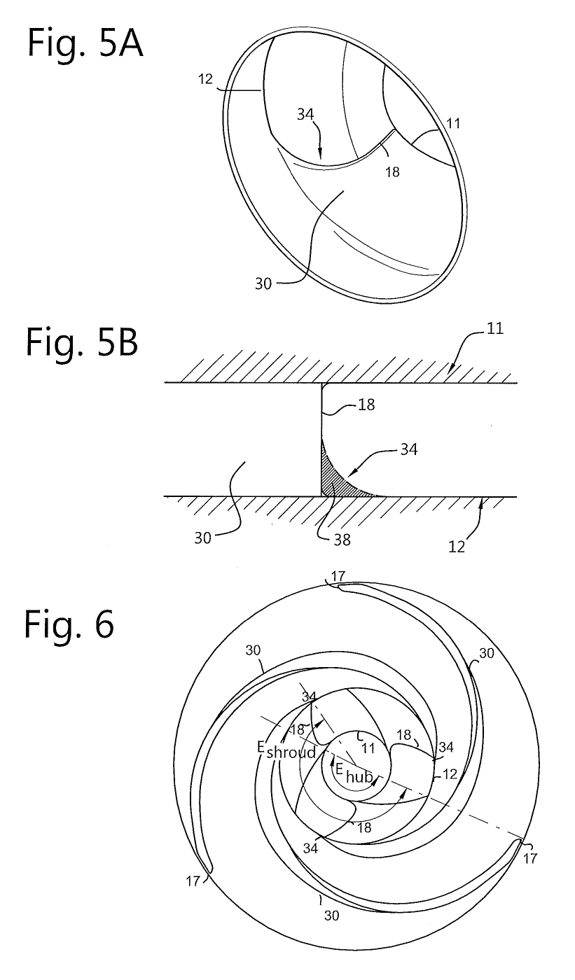

FIG. 5A shows a perspective view of the blade 30 leading edge 18 and front shroud 12 connection 34 according to an embodiment of the current invention; and FIG. 5B shows a side view blade 30, showing the connections 34 between the blade leading edge 18 and the front and rear shrouds 12, 11, showing connecting fillet 38 at connection 34. Connecting fillet 38 can extend about 10% to 50% across the length of leading edge 18 between front shroud 12 and rear shroud 11. The height of connecting fillet 38 along front shroud 12 can be about 20% to 75% of the thickness of blade without connecting fillet 38 (see FIG. 3C, original blade 31 thickness). The skilled person will appreciate that the connecting fillet 38 can be provided by known procedures such as casting, material deposition, welding, additive manufacturing, et cetera. By using one of these techniques, the implementation of the fillet becomes very versatile, independently of the dimensions of the pump and of the material employed for the fillet itself. Further, a connecting fillet 38 could also be included to connect blade 30 to back shroud 11.

In prior art pumps with the connection shown in FIGS. 4A-4B, a horse-shoe vortex sometimes formed at the intersection of the blade leading edge 18′ with the front and/or back shrouds 12′, 11′. The horse-shoe vortex forms when the flow along shrouds 11′, 12′ impacts the blade leading edge 18′. This can cause severe local damage when pumping slurry flows, and can also increase flow non-uniformity, resulting in hydraulic efficiency reduction.

The blade 30 of the current invention adds connecting fillet 38 to curve leading edge 18 toward front shroud 12 to obtain a smooth transition, as shown in FIGS. 5A-5B. Such a smooth transition minimizes frontal impact of the flow along front shroud 12 on blade 30 leading edge 18. Thus, the addition of fillet 38 helps to gradually guide flow along leading edge 18, thereby minimizing or avoiding horse-shoe vortices and the associated damage. A similar fillet can also be added at the connection to back shroud 11, though not shown in FIG. 5B.

FIG. 6 shows a perspective view of an impeller, and showing the blade wrap angles “E”. Typical prior art impellers had a constant wrap angle from suction shield 12 to shaft shield 11, for example about 160 degrees. The impeller shown in FIG. 6 has a variable wrap angle which increases from shaft shield 11 to suction shield 12. This increase can be, for example, E_{hub}=180 deg. To E_{shroud}=210 deg. Increasing the wrap angle, for example between zero and sixty degrees, from shaft shield 11 to suction shield 12 results in forward sweep of blade 30. This leads to improved flow uniformity, resulting in higher hydraulic efficiency.

Sweeping blade 30 also benefits wear characteristics. The incident flow will not impact perpendicular on a swept blade leading edge 18, but at an angle, resulting in less wear than on a non-swept blade which has perpendicular impacts. Forward sweep also increases blade 30 length in the direction of increasing inlet velocity and thus in the direction of increasing wear. The inlet velocity of blade 30 increases from shaft shield 11 to suction shield 12 simply because the radius of the blade 30 leading edge 18 increases in this direction. In time, a forward swept blade will wear off towards a non-swept geometry whereas a non-swept blade will wear off towards a backward sweep. Thus, adding a forward sweep to blade 30 helps the impeller deteriorate more slowly over time. Further, forward sept blades can generate a significant increase in blade overlap, which leads to an increase in flow uniformity.

In summary, impeller with blade 30 which has an increased thickness at and near the leading edge 18 on both suction and pressure sides and an extensive connecting fillet 38 at connection 34 of leading edge 18 to suction shield 12 results in an overall more efficient pump and a blade better able to resist wear and prolong the overall working life of the blade 30 and overall pump 1. By making blade 30 have a cross-sectional thickness about 25%-100% thicker at or near the leading edge 18; blade 30 is less sensitive to the incident flow beyond the best efficiency point and allows flow to remain attached to the blade surface even at larger incidence angles. This can keep smooth flow and efficiency in the pump over a large flow range, and the additional material serves to protect blade 30 against wear, increasing the lifespan of blade 30. The ability to add material at and near leading edge 18 and taper toward trailing edge 17 allows for prior art blades 15′, 15″ to be modified and adapted to have a thicker section and thereby gain the desired flow and wear characteristics without having to totally replace all prior art blades 15′ in prior art pumps.

Adding extensive connecting fillet 38 at connection 34 between leading edge 18 and suction shield 12 provides a smooth transition that minimizes frontal impact of the flow along front shroud 12 on blade 30 leading edge 18 and helps to gradually guide flow to minimize or avoid horse-shoe vortices and the associated damage. Adding a forward sweep to blade helps to reduce the impact velocity of incident flow and creates additional blade length in the direction of increasing wear to further prolong the life of blade 30.

While the invention has been shown with four blades, it will be understood that any suitable number of rotor blades may be provided, such as for instance three or five rotor blades 30. Further, while specific blade and fillet geometries have been shown, these are for example purposes only, and the thickening of blade 30 could be different sizes as well as different thickening and tapering geometry toward trailing edge 17. Further the sweep angles provided are also examples, and different pumps can have different sweep angles.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. Impeller for a centrifugal pump, the impeller comprising:
a rotor;
a shaft shield connected to the rotor and having an axial supply;
a suction shield connected to the rotor and axially set apart from the shaft shield; and
a plurality of blades between the shaft shield and suction shield and connected to the rotor;
each blade comprising a leading edge and a trailing edge connecting between the shaft shield and the suction shield and a suction side and a pressure side, wherein each blade cross-section is thicker near the leading edge on the suction and pressure sides, and tapers to a thinner cross-section near the trailing edge, and each blade connects to the suction shield at the leading edge with an extensive connecting fillet providing curvature toward the suction shield along the leading edge.

2. The impeller of claim 1, wherein each blade comprises forward sweep.

3. The impeller of any of the preceding claims, wherein the cross-section of each blade is 25% to 80% thicker at the thickest point near the leading edge than near the trailing edge.

4. The impeller of claim 1, wherein each blade has a maximum cross-sectional thickness at 5% to 30% along the length of the blade, after which the blade tapers in cross-sectional thickness toward the trailing edge.

5. The impeller of claim 1, wherein a blade wrap angle (E_{shroud}−E_{hub}) of each blade is variable from suction shield to shaft shield.

6. The impeller of claim 5, wherein the increase in blade wrap angle (E_{shroud}−E_{hub}) is between 0 and 60 degrees with a forward sweep.

7. The impeller of claim 1, wherein the connecting fillet extends over 10% to 50% of the leading edge length between suction and shaft shields.

8. The impeller of claim 1, wherein the blade comprises a leading edge and a trailing edge, with a cross-section which is at least 50% thicker on both suction and pressure sides near the leading edge than near the trailing edge.

9. The impeller of claim 8, wherein the blade thickness is provided by a fillet which wraps around the leading edge of an original blade and extends toward the trailing edge.

10. The impeller of claim 9, wherein the fillet is a constant thickness for about 10% of the blade length between leading edge and trailing edge before tapering.

11. The impeller of claim 1, wherein the connecting fillet height along the suction shield is 20% to 75% of the original blade thickness.

12. The impeller of claim 1, wherein blade leading edge connects to the shaft shield with a connecting fillet.

13. Centrifugal pump comprising the impeller of claim 1, the centrifugal pump comprising:
a pump housing with an axial inlet and an outlet;
the impeller connected to the pump housing through the rotor being connected to the pump housing such that the rotor can rotate around an axis A; and
the shaft shield having the axial supply aligned with the axial inlet.

14. A vessel comprising the centrifugal pump according to claim 13.

15. A blade for the centrifugal pump of claim 13, the blade comprising a leading edge and a trailing edge, with a cross-section which is at least 50% thicker on both suction and pressure sides near the leading edge than near the trailing edge and tapers between.

16. The blade of claim 15, wherein the blade thickness is provided by a fillet which wraps around the leading edge of an original blade and extends toward the trailing edge.

17. The blade of claim 16, wherein the fillet is a constant thickness for about 10% of the blade length between leading edge and trailing edge before tapering.

18. A method of modifying an original blade for a centrifugal pump, the method comprising:
adding material to the original blade at and near the leading edge to the suction and pressure sides of the blade; and
tapering the added material in a direction toward the trailing edge.

19. The method of claim 18, wherein the step of adding material to the original blade at and near the leading edge comprises wrapping material around the leading edge and extending toward the trailing edge on both sides of the original blade such that the material is a constant thickness for 10% of the blade length between leading edge and trailing edge.

20. The method of claim 18, wherein the material added is the same material as that of the original blade.
